(19) United States
(12) Patent Application Publication
(10) Pub. No.: US 2025/0221379 A1
(43) Pub. Date: Jul. 10, 2025

(54) CABLE DRIVE UNIT FOR FREE STALL CLEANER SYSTEM

(71) Applicant: VALMETAL ST-FRANÇOIS INC., Saint-François-Xavier-de-Brompton (CA)

(72) Inventor: Ralph FANNING, Saint-François-Xavier-de-Brompton (CA)

(21) Appl. No.: 19/016,348

(22) Filed: Jan. 10, 2025

Related U.S. Application Data
(60) Provisional application No. 63/619,681, filed on Jan. 10, 2024.

(51) Int. Cl. A01K 1/01

(52) U.S. Cl. CPC A01K 1/0132

(57) ABSTRACT

A cable drive unit for cleaning a free stall comprises a housing defining opposite lateral sides and opposite longitudinal ends defining respective cable openings. A cable drive assembly is mounted within the housing and comprises a shaft mounted to the housing lateral sides. A drum is rotatably mounted to the shaft about a hub and sleeve structure thereof. The hub and sleeve structure mechanically interfaces with a length of the shaft for providing lateral displacement of the drum thereon between the lateral sides of the housing during rotation of the drum. The drum provides for receiving a wound cable thereon. Rotational movement of the drum provides for unwinding the cable therefrom to be moved outwardly of the opening of one of the longitudinal ends and simultaneously moving the cable inwardly at the other one of the longitudinal ends for being wound onto the drum thereby moving scrapers when mounted to the cable.

### CROSS-REFERENCE TO RELATED APPLICATIONS

The present application claims priority of U.S. Provisional Patent Application Ser. No. 63/619,681 filed Jan. 10, 2024 and incorporated herein by reference in its entirety.

### TECHNICAL FIELD

The present disclosure generally relates to free stall cleaning. More particularly, but not exclusively, the present disclosure relates to a cable drive unit for a free stall cleaner system.

### BACKGROUND

Free stall cleaner systems and with cable drive units are well known and are used to dean the alleys of a free stall barn. Cows are usually free to walk in the barn and manure accumulates in the alleys between the stall areas. These units include a rotatable drum with cable wound on its surface. The cable has two “free” ends both of which are mounted to the drum. The drum during rotation provides for moving the cable, cable unwound from drum at one end of the unit and wound onto the drum at the opposite end of the unit and vice versa depending on the direction of the drum's roration. In this way, the cable is moved along the alleys reciprocally moving along one linear direction and then the opposite direction depending on which end of the cable is wound and which is unwound by the rotating drum. The cable includes scrapers moved by the cable for pushing the manure into disposal slots in the alleys. Corner wheels are used to shape the cable closed loop layout about the barn stall configuration so that the scrapers reciprocally move along towards and away the unit and towards and away the slots.

### OBJECTS

An object of the present disclosure is to provide a cable drive unit.

An object of the present disclosure is to provide a free stall cleaning system.

### SUMMARY

In accordance with an aspect of the present disclosure, there is provided a cable drive unit for cleaning a free stall, the cable drive unit comprising: a housing defining opposite lateral sides and opposite longitudinal ends defining respective cable openings; a cable drive assembly mounted within the housing, the cable drive assembly comprising: a shaft fixedly mounted to the lateral sides of the housing; a drum being rotatably mounted to the shaft about a hub and sleeve structure thereof, the hub and sleeve structure mechanically interfacing with a length of the shaft for providing lateral displacement of the drum thereon between the lateral sides of the housing during rotation of the drum, the drum providing for receiving a wound cable thereon; and an actuation assembly in operative communication with the drum for selectively imparting a rotational movement thereto, wherein rotational movement of the drum provides for unwinding the cable therefrom to be moved outwardly of the opening of one of the longitudinal ends and simultaneously moving the cable inwardly at the other one of the longitudinal ends for being wound onto the drum thereby moving scrapers when mounted to the cable.

In an embodiment, the cable drive unit further comprises a support carriage positioned within the housing and movably mounted to the shaft and to the housing, the actuation assembly being mounted to the support carriage.

In an embodiment, the support carriage is mounted to the hub and sleeve structure via collar elements providing for the hub and sleeve structure to rotate therein.

In an embodiment, the carriage is slidably mounted to a guide at one of the one of the longitudinal ends of the housing.

In an embodiment, the hub and sleeve structure comprises an internal threaded surface and the shaft comprises a worm gear surface along the length for complementary engagement with internal threaded surface to provide the lateral displacement movement.

In an embodiment, the hub and sleeve structure encloses a nut therein, the nut comprising the internal threaded surface and being rotatable about the shaft in conjunction with the hub and sleeve structure and laterally displaceable along the length of the shaft during rotation thereof in conjunction with the hub and sleeve assembly. In an embodiment, the hub and sleeve structure comprises a pair of hub and sleeve parts connected together about the nut for sealingly enclosing the nut therein.

In an embodiment, the hub and sleeve structure comprises disks radially extending therefrom connected to a frame of the drum.

In an embodiment, the actuation assembly is operatively connected to the hub and sleeve structure. In an embodiment, the actuation assembly comprises a roller chain mounted to a sprocket and being connected to the hub and sleeve structure for imparting the rotational movement thereto. In an embodiment, the hub and sleeve structure comprises a disk radially extending therefrom mounted a frame of the sprocket. In an embodiment, the sprocket is positioned parallel to the drum. In an embodiment, the sprocket has a small diameter than the drum and is positioned further away from a ground level than the drum. In an embodiment, the sprocket is at least partially covered.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

The following drawings form part of the present specification and present disclosure. In the appended drawings:

FIG. 1 is a front, right side and top perspective view of the cable drive unit in accordance with a non-restrictive illustrative embodiment of the present disclosure;

FIG. 2 is a front, left and top perspective view of the cable drive unit of FIG. 1 with a part of the housing thereof being open and showing the cable drive assembly therein in accordance with a non-restrictive illustrative embodiment of the present disclosure;

FIG. 3 is a front, right side and top perspective view of the cable drive unit of FIG. 1 with a part of the housing thereof being open and showing the cable drive assembly therein and of a pair of scrapers in accordance with a non-restrictive illustrative embodiment of the present disclosure;

FIG. 4 is a rear side view of the cable drive unit of FIG. 1, with a cable extending therefrom into a stall area via a corner wheel in in accordance with a non-restrictive illustrative embodiment of the present disclosure;

FIG. 5 is schematic plan view of a free stall cleaner system with the cable drive unit of FIG. 1 installed in free stall area in accordance with a non-restrictive illustrative embodiment of the present disclosure;

FIG. 6 is a top plan view of four configurations of the cable drive unit of FIG. 1 with the cable extending therefrom at different angles in accordance with a non-restrictive illustrative embodiment of the present disclosure;

FIG. 7 is a front, left side and top perspective view of the cable drive assembly of the cable drive unit of FIG. 1 in accordance with a non-restrictive illustrative embodiment of the present disclosure;

FIG. 8 is an exploded perspective of the actuation assembly of the cable drive assembly of FIG. 7 in accordance with a non-restrictive illustrative embodiment of the present disclosure;

FIG. 9 is an exploded perspective view of the drum and actuation assembly of the cable drive assembly of FIG. 7 in accordance with a non-restrictive illustrative embodiment of the present disclosure;

FIG. 10 is a perspective and partial view of the drum, hub and sleeve structure and drum shaft assembly of the cable drive assembly of FIG. 7 in accordance with a non-restrictive illustrative embodiment of the present disclosure;

FIG. 11 is a perspective view of a hub and sleeve component of the hub and sleeve structure of FIG. 10 in accordance with a non-restrictive illustrative embodiment of the present disclosure;

FIG. 12 is a perspective view of the drum shaft with a nut mounted thereon of the cable drive assembly of FIG. 7 in accordance with a non-restrictive illustrative embodiment of the present disclosure;

FIG. 13 is FIG. 12 is a perspective view of the drum shaft with a nut mounted thereon and a substantially transparent version the hub and sleeve structure provided for illustrative purposes, the foregoing forming part of the cable drive assembly of FIG. 7 and being illustrated in accordance with a non-restrictive illustrative embodiment of the present disclosure shown in translucent;

FIG. 14 is perspective view of the drum shaft with the hub and sleeve structure mounted thereto of the cable drive assembly of FIG. 7 in accordance with a non-restrictive illustrative embodiment of the present disclosure;

FIG. 15 is a perspective slightly right side view of a transparent version of the drum shown for illustrative purposes mounted to the hub and sleeve structure which is mounted to the drum shaft, the foregoing forming part of the cable drive assembly of FIG. 7 and being illustrated in accordance with a non-restrictive illustrative embodiment of the present disclosure shown in translucent;

FIG. 16 is a front perspective view of the drum with the sprocket therefor mounted to the drum shaft via the hub and sleeve assembly, the foregoing forming part of the cable drive assembly of FIG. 7 and being illustrated in accordance with a non-restrictive illustrative embodiment of the present disclosure shown in translucent;

FIG. 17 is a front and left side view of the drum and a transparent version of the actuation assembly shown for illustrative purposes, the foregoing forming part of the cable drive assembly of FIG. 7 and being illustrated in accordance with a non-restrictive illustrative embodiment of the present disclosure shown in translucent;

FIG. 18 is another front, left side and top perspective view of the cable drive assembly of the cable drive unit of FIG. 1 in accordance with a non-restrictive illustrative embodiment of the present disclosure;

FIG. 19 is a front, left side and top perspective view of the cable drive unit in an open position and in a transparent version thereof for illustrative purposes thereby showing the cable drive assembly of FIGS. 7 and 18 in accordance with a non-restrictive illustrative embodiment of the present disclosure;

FIG. 20 is a cross-sectional top plan view of the cable drive assembly taken along the length of the drum shaft in accordance with a non-restrictive illustrative embodiment of the present disclosure;

FIG. 21 is an exploded perspective view of the carriage of the cable drive assembly of FIG. 7 in accordance with a non-restrictive illustrative embodiment of the present disclosure;

FIG. 22 is an exploded view of the bottom part of the housing of the cable drive unit of FIG. 1 in accordance with a non-restrictive illustrative embodiment of the present disclosure;

FIG. 23 is a front, left and top view of a front part of the cable device unit of FIG. 1 with an open housing showing the cable drive assembly when moved in one lateral direction in accordance with a non-restrictive illustrative embodiment of the present disclosure; and

FIG. 24 is a front, left and top view of a front part of the cable device unit of FIG. 1 with an open housing showing the cable drive assembly when moved in another lateral direction in accordance with a non-restrictive illustrative embodiment of the present disclosure.

### DETAILED DESCRIPTION

Generally stated, there is provided a cable drive unit for cleaning a free stall. The cable drive unit comprises a housing defining opposite lateral sides and opposite longitudinal ends defining respective cable openings. A cable drive assembly is mounted within the housing. The cable drive assembly comprises a shaft fixedly mounted to the lateral sides of the housing. A drum is rotatably mounted to the shaft about a hub and sleeve structure thereof. The hub and sleeve structure mechanically interface with a length of the shaft for providing lateral displacement of the drum thereon between the lateral sides of the housing during rotation of the drum. The drum provides for receiving a wound cable thereon and during rotation thereof provides for unwinding the cable therefrom at one longitudinal end of the housing and provides for simultaneously winding the cable thereon and the other longitudinal end of the housing. An actuation assembly is in operative communication with the drum for selectively imparting a rotational movement thereto. Rotational movement of the drum provides for unwinding the cable therefrom to be moved outwardly of the opening of the one of the longitudinal ends and simultaneously moving the cable inwardly at the other one of the longitudinal ends for being wound onto the drum thereby moving scrapers when mounted to the cable.

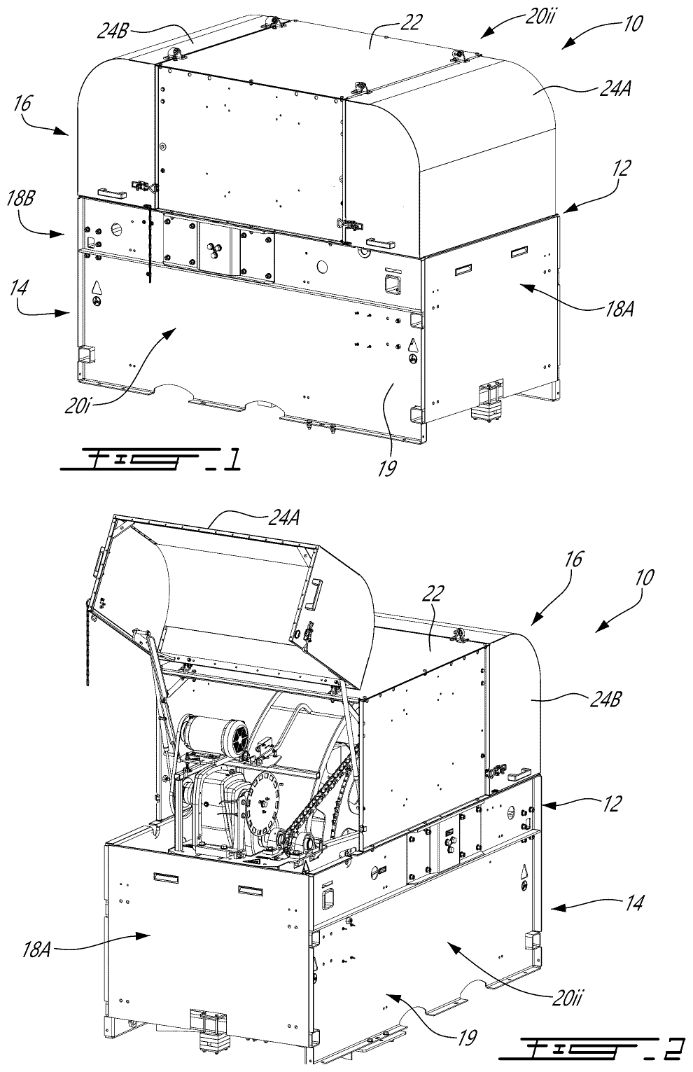

With reference to FIGS. 1 to 4, there is shown a cable drive unit 10 comprising a housing 12 defining a bottom part 14 and a top part 16, opposite longitudinal ends (or front and rear end 18A and 18B) and opposite lateral sides 20i and 20ii. As will be further explained below, the terms “front”, “rear” and “lateral” are used herein for descriptive purposes only and are thus interchangeable. Indeed, the cable drive unit 10 provides for driving a closed loop cable system within the alleys of free stalls in which positions/directions such as “front”, “rear” and “lateral” are relative. The bottom part 14 comprises a chassis 19.

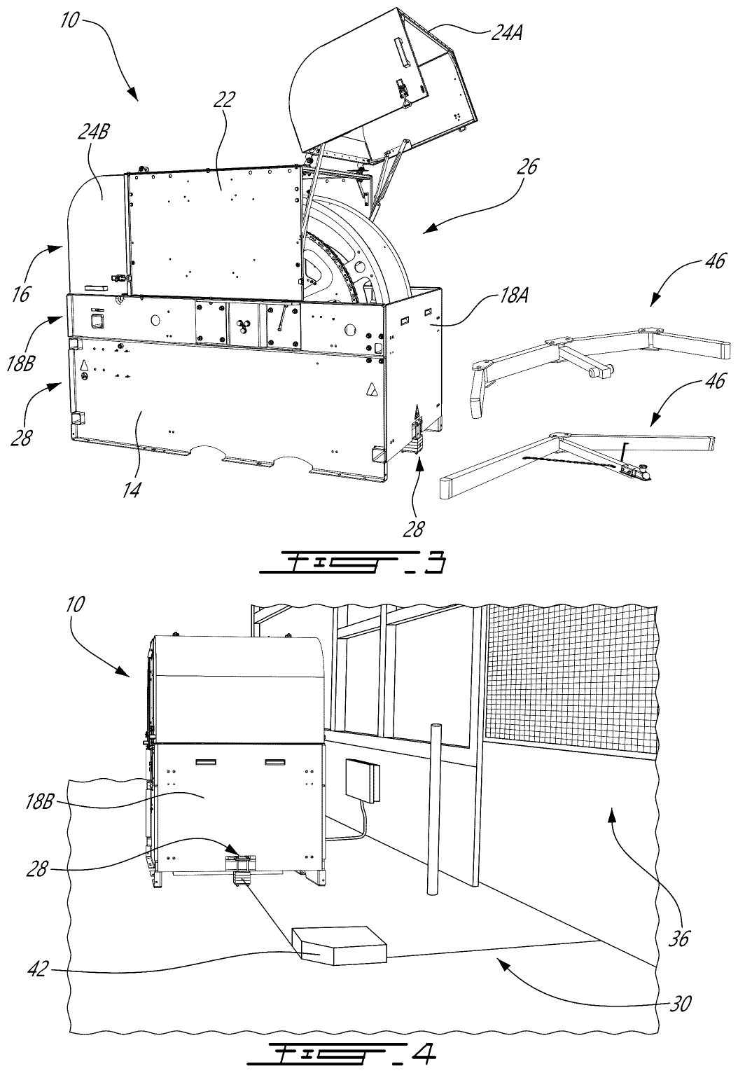

The top part 16 comprises a top cover 22 interposed between opposite guard doors 24A and 24B at each the front and rear ends 18A and 18B, respectively. The guard doors 24A and 24B are hinged to the top cover 22 for being moved between closed and opened positions for selective access to the cable drive assembly 26 shown in FIGS. 2 and 3 for example.

The bottom part 18 defines openings 28 at each front and rear end 18A and 18B for the cable 30 to extend outwardly therefrom.

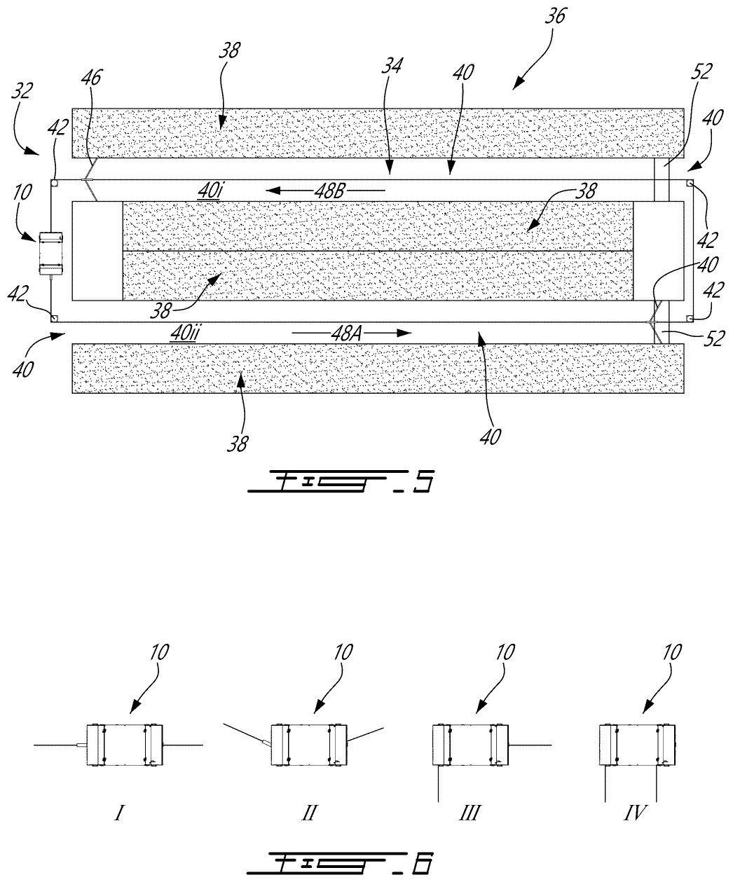

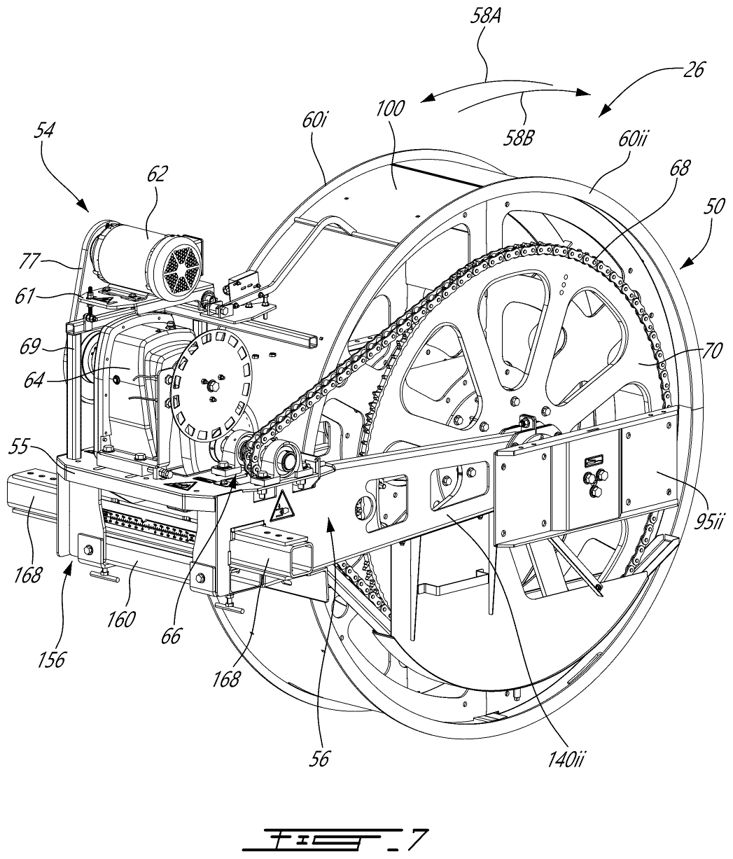

With reference to FIG. 5, the cable drive unit 10 is used for a free stall cleaner system 32. System 32 comprises a closed loop cable layout 34 with the cable 30 extending from the opening 28 at one end 18A of the drive unit 10 looping about a stall layout 36 back into the drive unit 10 via the opening 28 at the other end 18B. The stall layout 36 includes rows of stall areas 38 spaced apart by alleys or passages 40. The cable 30 runs about theses alleys or passages 40 between the stall areas 38. Corner wheels 42 (see also FIG. 4) allows the cable 30 to former corners or bends 44 and change directions so as to define the closed loop 34. Scrapers 46 (see also FIG. 3) are fixed to the cable 30 to be reciprocally driven along an alley or passage 40 from and towards the drive unit 10 as shown by arrows 48A and 48B. As the cable 30 is driven into end 18B it moves the scraper 46 in alley 40′ towards the drive unit 10 in the direction of arrow 48B and in tandem cable 30 is driven out of end 18A thereby moving the scraper 46 along alley 40″ in the direction of arrow 48A and vice versa depending on the rotational direction o the drum 50 (see FIGS. 2 and 3). The scrapers 46 push manure in the alleys 40′ and 40″ into slots 52.

As shown in FIG. 6, the cable 30 extends from the drive unit 30 at various possible directions, examples of which are shown configurations I, II, II and IV. The foregoing is provided by the positioning of the corner wheels 42.

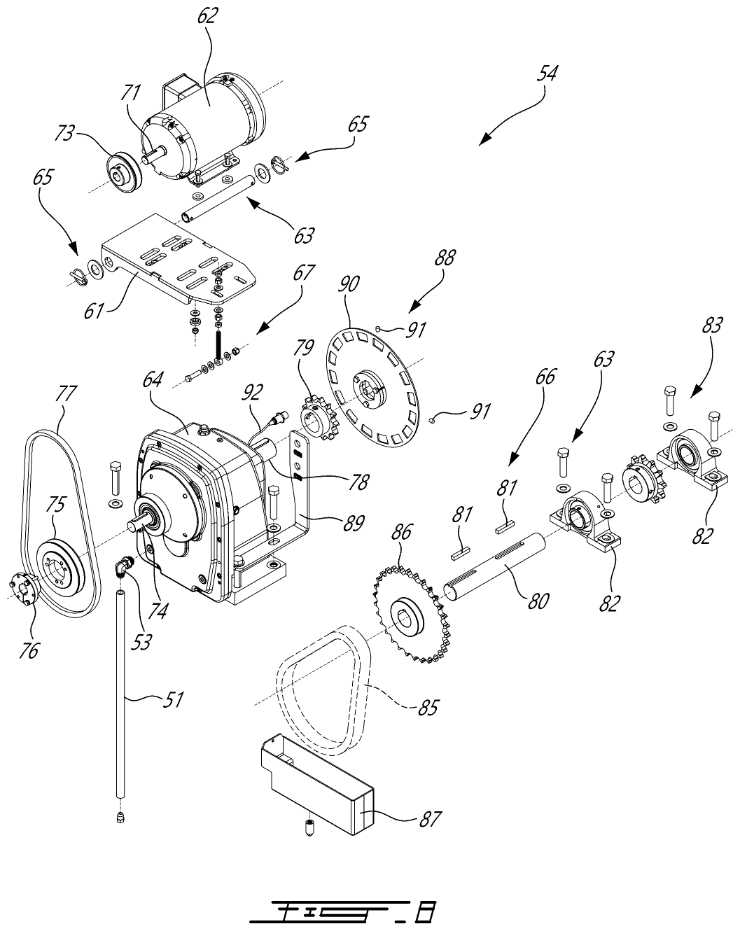

Turning to the FIG. 7, there the cable drive assembly 26 housed within housing 12 comprises the drum 50 and a movement imparting or actuator assembly 54 mounted on a carriage 56. The actuator assembly 54 provides for selectively imparting a bi-directional rotational movement to the drum as shown by arrows 58A and 58B. The cable 30 is mounted to the drum 50. Indeed, the cable includes separate ends thereof separately mounted to the drum 50. The drum 50 includes lateral guard rails 60i and 60ii and each separate end of the cable 30 is mounted towards one of the respective guard rails 60i and 60ii.

With reference to both FIGS. 5 and 7, when the drum 50 rotates in the direction shown by arrow 58A, the cable 30 is moved outwardly of opening 18A and into opening 18B, thereby the scraper 46 in alley 40″ is moved in the direction shown by arrow 48A and the scraper 46 in alley 40′ is moved in the direction shown by arrow 48B. When the drum 50 rotates in the direction shown by arrow 58B, the cable 30 is moved into opening 18A and outwardly of opening 18B, thereby the scraper 46 in alley 40″ is moved in the direction shown by arrow 48B and the scraper 46 in alley 40′ is moved in the direction shown by arrow 48A.

With reference to FIGS. 7 and 8, the actuator assembly 54 comprises a motor 62 in operative communication with a gearbox or transmission 64 which rotate a driver 66 driving a roller chain 68 mounted to a gear or sprocket 70 in operative communication with the drum 50 for imparting the rotational movement to the drum 50 in the directions shown by arrows 58A and 58B.

A hydraulic hose 51 with an elbow 53 provides hydraulic fluid to the actuator assembly.

The motor 62 is positioned on a motor-mount 61 and is connected thereto via a motor-mount tube 63 with linchpin and washer elements 65. The motor-mount 61 is bolted via bolts 67 to a frame 69 extending from a table part 55 of the carriage 56. The motor 62 has a motor output shaft 71 with a motor sheave 73 mounted thereon. The transmission 64 is mounted to the table part 55 and has an input shaft 74 with a sheave 75 mounted thereon along with a bushing 76. Operative communication between the motor 62 and the transmission 64 is provided by a belt 77 mounted to the motor sheave 73 and the transmission sheave 75. Thus, rotational movement of the output shaft 71 is transferred to the input shaft 74. The transmission 64 includes an output shaft 78 with a transmission sprocket 79 mounted thereon.

The driver 66 has a drive shaft 80 with keys 81 and is rotatably supported by pillow block bearings 82 mounted to the table part 55 via bolts 83. A driver sprocket 84 is mounted to the drive shaft 80 for being rotated thereby and consequently driving roller chain 68 which rotates the sprocket 70. Operative communication between the transmission 64 and the driver 66 is provided by a roller chain 85 mounted to sprocket 79 and to sprocket 86 which is connected to the drive shaft 80 thereby transferring the rotational movement of the output shaft 78 to the drive shaft 80. The roller chain 85 is partially housed within an oil pan 87.

The transmission 64 includes a sensor assembly 88 mounted to a sensor bracket 89 including encoder measuring wheel 90 with set screws 91 and a proximity sensor 92. The encoder measuring wheel 90 is positioned right behind sprocket 79 and counts the number of times sprocket 79 has rotated thereby determining the rotational movement of the drum 50 and the lateral displacement movement towards a respective lateral side (20i or 20ii) of the carriage 56 and drum 50 as will be further described herein.

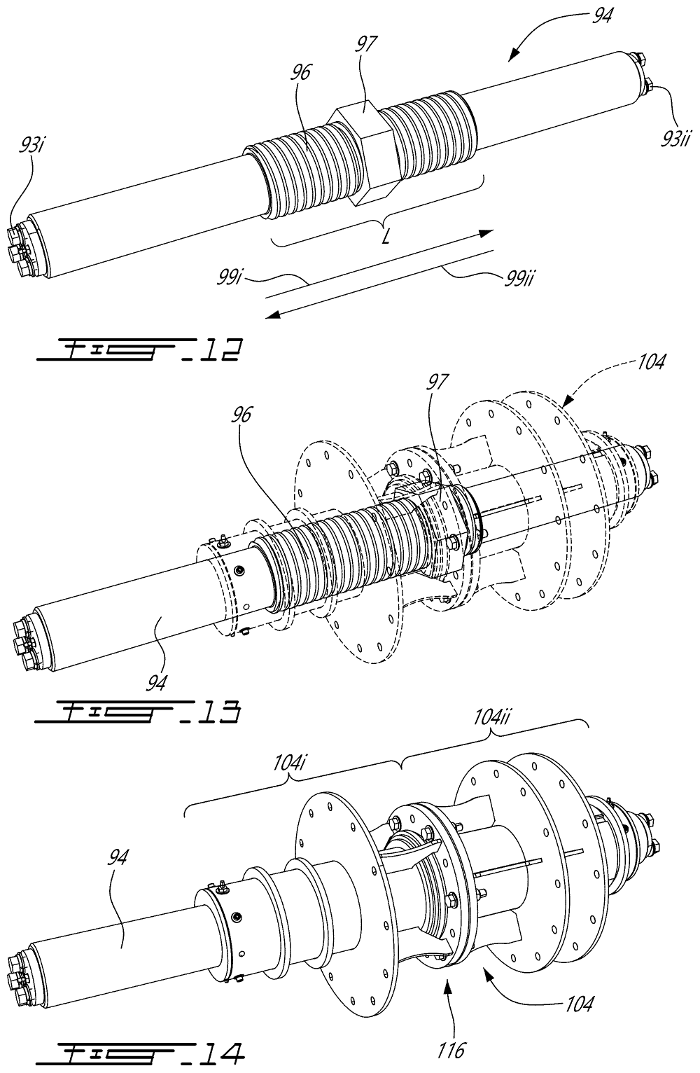

With reference to FIGS. 7 and 8, the drum 50 is mounted to a longitudinal drum shaft 94 fixed at both ends 93i and 93ii to a shaft end plates 95i and 95ii at each lateral side 20i, 20ii of the bottom part 16 of the housing 12. As shown in FIGS. 8 and 12, the drum shaft 94 includes a worm gear 96 extending along a length L thereof. A threaded nut 97 is positioned on the worm gear 96. The threaded nut 97 includes an inner threaded surface 98 that is complementary to the worm gear 96 for allowing the nut 97 to rotate thereon for lateral displaced along the length L of the worm gear in the direction shown by arrow 99ii (i.e. towards end 93ii) when the drum 50 is rotating in the direction shown by arrow 58A and in the direction shown by arrow 99i (i.e. towards end 93i) when the drum 50 is rotated in the direction shown by arrow 58B.

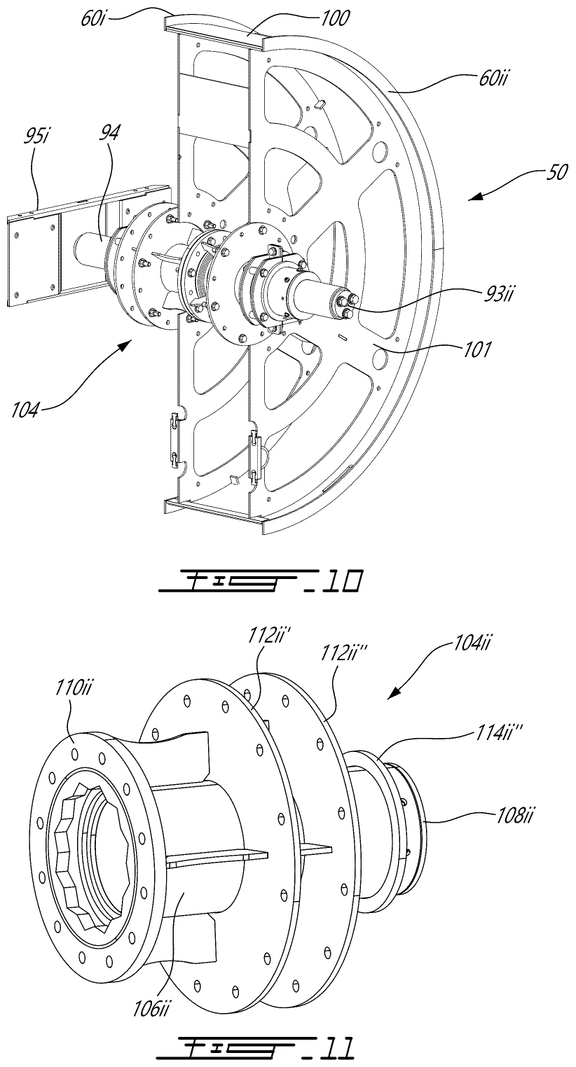

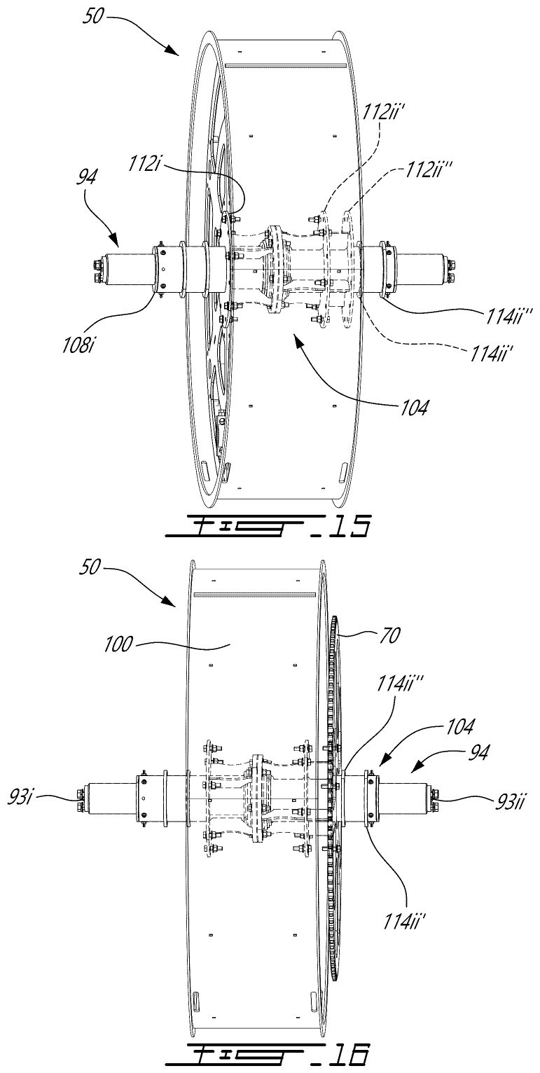

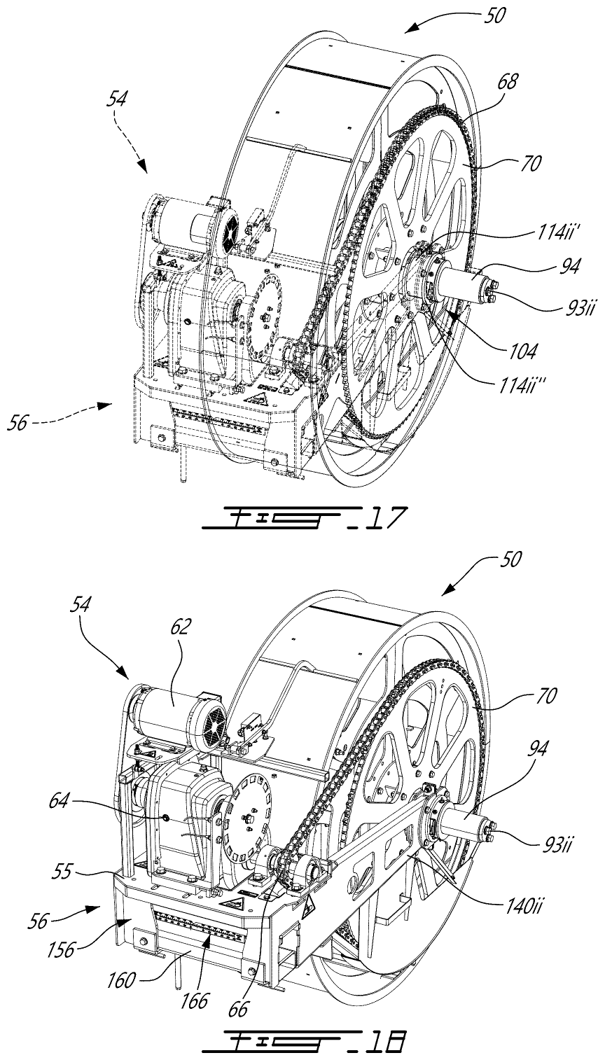

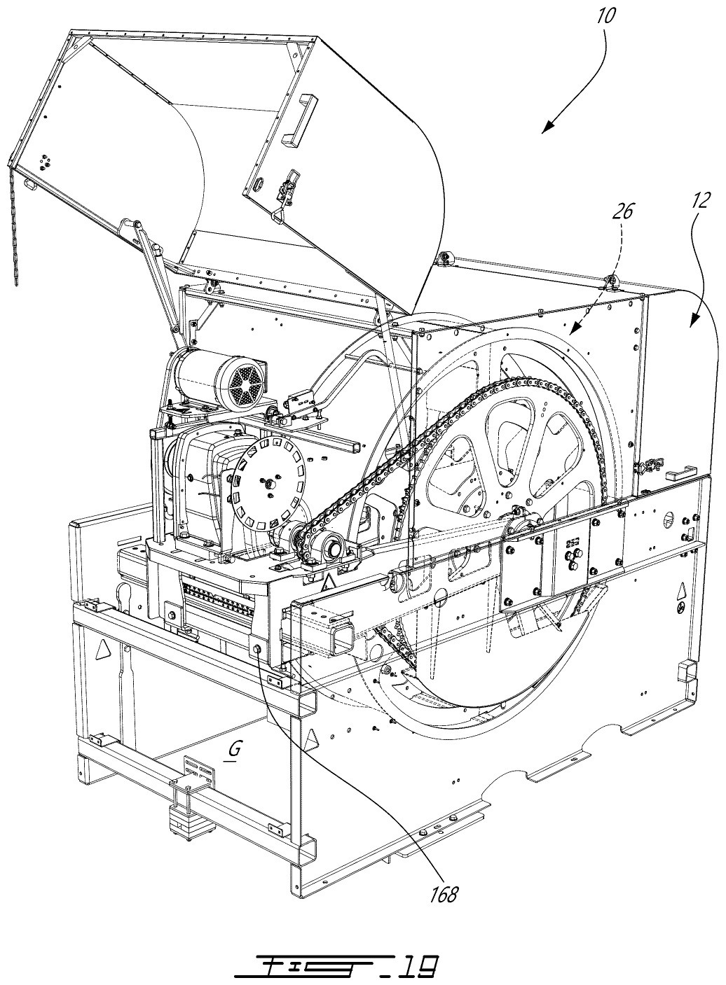

The drum 50 defines an outer circular surface 100 for receiving the cable 30 thereon. The surface 100 is bounded by lateral guard rails 60i and 6ii and supported by an inner spoke structure or frame 101 defining a central opening 102. The opening 102 receives a hub and sleeve structure 104 therethrough shown in FIGS. 10 and 15. As shown in FIGS. 10, 13, 14, and 15, the hub and sleeve structure 104 is rotatably mounted to the fixed hub shaft 94 and encloses the nut 97 therein as and better shown in FIG. 13. Therefore, rotational movement of the drum 50 causes the hub and sleeve structure 104 to rotate along with the nut 97. The nut 97 is displaced during rotation about the length L of the worm gear 96 and displaces the hub and sleeve structure 104 with it which displaces the drum 50 therewith as well in the direction of arrows 99i and 99ii. As such, the drum 50 is rotatable forwardly and rearwardly (arrows 58A and 58B) as well as laterally from sides 20i to 20ii of the housing 12. The movements of the drum 50 are all imparted within the enclosed housing 12.

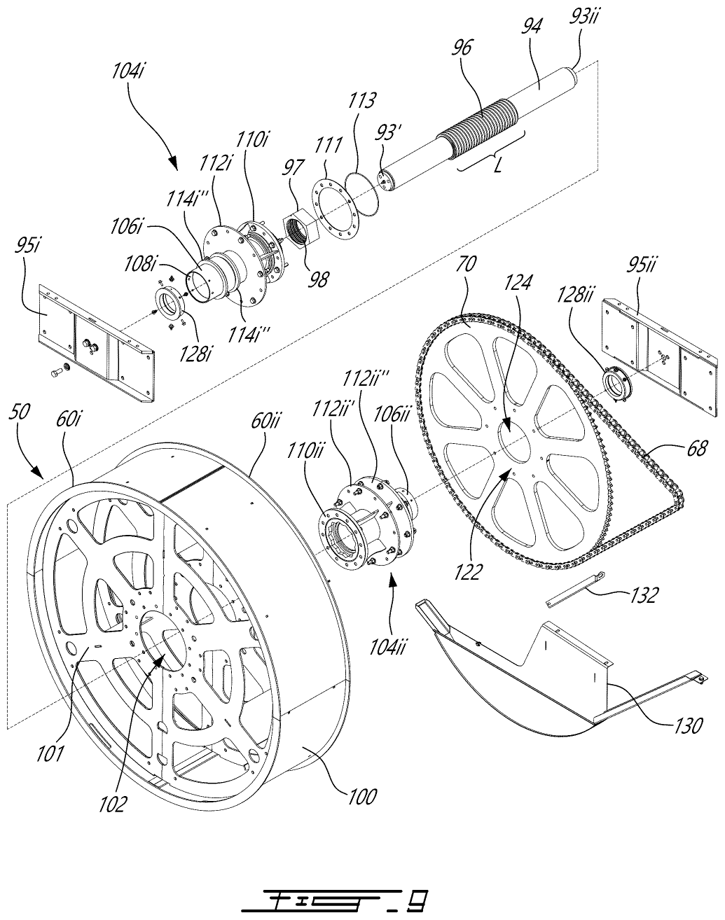

With reference to FIGS. 9, 11,14,15 and 16 the hub and sleeve structure 104 comprises a pair of hub sleeve parts 104i and 104ii providing for the shaft 96 and the nut 97 to be positioned therethrough. The hub sleeve part 104i comprises a sleeve body 106i with a free end 108i and a flange 110i at the other end thereof. A hub disk 112i radially extends from the sleeve body 106i and is positioned between the free end 108i and the flange 110i. A pair of ridges 114i′ and 114i″ are positioned between the hub disk 112i and the free end 108i. The hub sleeve part 104ii comprises a sleeve body 106i with a free end 108ii and a flange 110ii at the other end thereof. A pair of hub disks 112ii′ and 112ii″ radially extend from the sleeve body 106ii and are positioned between the free end 108ii and the flange 110ii. A pair of ridges 114ii′ and 114ii″ are positioned between the hub disk 112ii and the free end 108ii.

With reference to FIGS. 9, 14, and 20, the hub sleeve parts 104i and 104ii are connected to form the hub sleeve structure 104 via their respective flanges 110i and 110ii being bolted together and sealed with an O-ring flange 111 and an O-ring seal 113. When connected, the flanges 110i and 110ii form a common structure 116 sealingly housing therein the nut 97. Since the common structure 116 is secured to the nut 97, rotation of the hub and sleeve structure 104 causes rotational engagement of the nut 97 about the worm gear 96 and as such lateral displacement thereon along length L as previously described. The hub disk 112i is connected to a hub portion 118i of the drum frame 101 via bolts 120. The hub disk 112ii′ is connected to another hub portion 118ii of the drum frame 101 via bolts 120. The hub portions 118i and 118ii circumscribe the central opening 102. The disk 112ii″ is connected to the sprocket 70 at its hub portion 122 circumscribing a central opening 124 via bolts 126. The sprocket central opening 124 provides for receiving the shaft 94 therethrough. Thus, rotation of the sprocket 70 causes rotation of the hub and sleeve structure 104 therewith which causes rotation of the drum 50 in tandem with rotation and displacement of the nut 97. Nylon rings 128i and 128ii are fitted within the ends 108i and 108ii to slidably engage the shaft 94 allowing for both rotational and translational movement of the hub and sleeve structure 104 (in conjunction with the nut 97) and for proper and stable fitting of the hub and sleeve structure 104 about the shaft 94 thereby resulting in a stable drum 50 during rotational and translational (along the length L) movements.

The sprocket 70 is protected with an oil pan 130 including an oil pan gutter 132. Thus, the sprocket 70 is partially covered. In addition to this partial covering of the sprocket 70, the sprocket is positioned next to the drum 50 and has a much smaller diameter than the drum 50 which provides it to be positioned higher from the ground level where manure has accumulated and is being scraped. The foregoing is more convenient to directly placing the roller chain 68 on the drum 50 which has a much greater diameter 50. As shown in FIG. 19, the ratio of the gears allows for positioning the cable drive assembly 26 higher up from the ground level G where manure and debris have accumulated. The cable drive assembly 26 is protected within the housing 12.

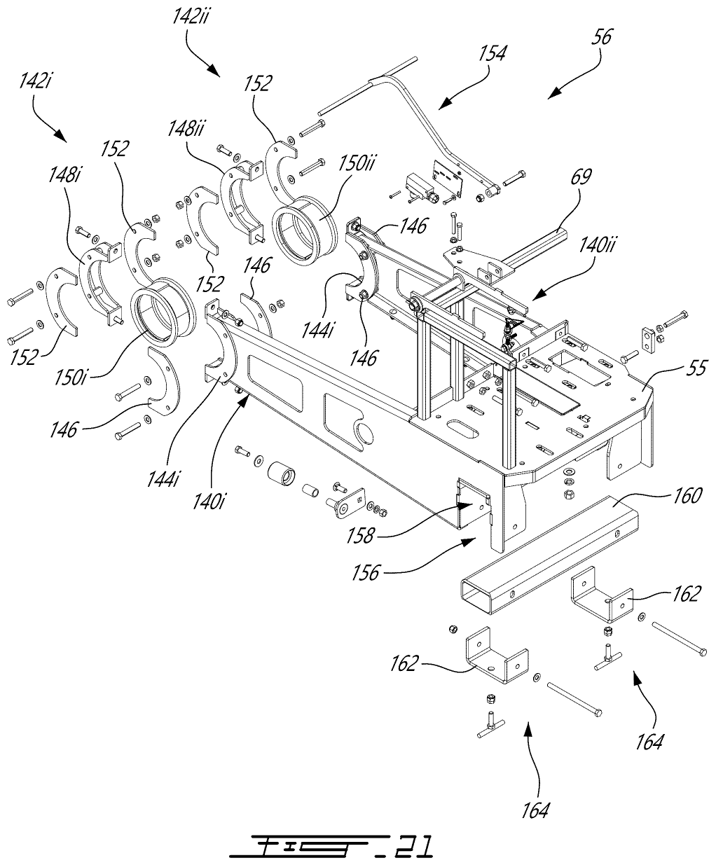

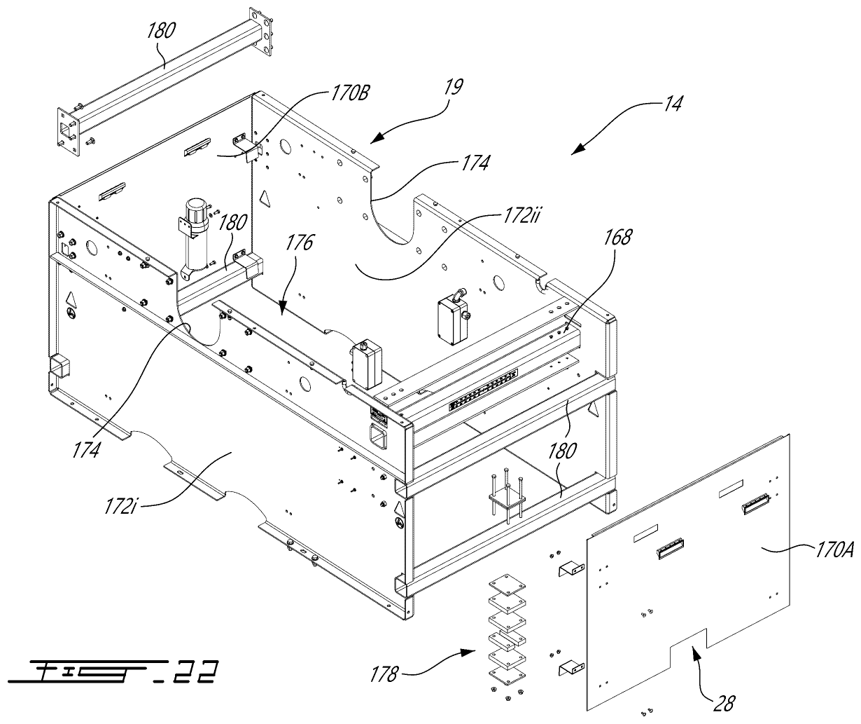

Turning now to FIG. 21, there is shown the carriage 56 comprising the main table part 55 with the frame 69 upwardly extending therefrom. A pair os spaced apart arms 140i and 140ii rearwardly extend from the table part 55 and engage the hub and sleeve structure 104 (see also FIGS. 7, 18 and 20). More particularly and with reference to FIGS. 20 and 21, each arm 140i and 140ii comprises a distal collar 142i and 140ii. Collar 142i is positioned between ridges 114i′ and 114i″ and held in place therebetween so as not to move further along the length of sleeve part 106i and remain between ridges 114i′ and 114i″ which act as stoppers. Similarly, collar 142i is positioned between ridges 114ii′ and 114ii″ and held in place therebetween so as not to move further along the length of sleeve part 106ii and remain between ridges 114ii′ and 114ii″ which act as stoppers. As such, the hub and sleeve structure 104 rotates in the directions shown by arrows 58A and 58B in FIG. 7, the sleeves 106i and 106ii rotate within the collars 142i and 142ii. When the hub and sleeve 104 (in conjunction with the nut 97) is translationally displaced along the length L in the direction shown by arrow 99ii in FIG. 12, the ridge 114i″ pushes on the collar 142i in the direction shown by arrow 99ii with the ridge 114i′ stopping it on the other side thereof and at the same, the ridge 114ii′ pushes on collar 142ii in the direction shown by arrow 99ii with the 114ii″ ridge stopping it on the other side thereof. The foregoing provides for the arms 140i and 140ii and as such, the carriage 56 to move in the direction shown by arrow 99ii. When the hub and sleeve 104 (in conjunction with the nut 97) is translationally displaced along the length L in the direction shown by arrow 99i in FIG. 12, the ridge 114i″ pushes on the collar 142i in the direction shown by arrow 99i with the ridge 114i′ stopping it on the other side thereof and at the same, the ridge 114ii″ pushes on collar 142ii in the direction shown by arrow 99i with the 114ii′ ridge stopping it on the other side thereof. The foregoing provides for the arms 140i and 140ii and as such, the carriage 56 to move in the direction shown by arrow 99i.

With reference to FIG. 21, each collar 142i and 142ii comprises a respective base half collar 144i and 144ii formed at the free end of its respective arm 140i and 140ii, respectively. The base half collars 144i and 144ii are sandwiched between plates 146. The half collars 144i and 144ii are completed with half collar parts 148i and 148ii respectively and respective rings 150i and 150ii are positioned therein so that each collar 142i and 142ii carries a respective ring 150i and 150ii which allow for rotational movement therein of the hub and sleeve structure 104. The half collar parts 148i and 148ii are respectively sandwiched by plates 152.

A safety arm 154 for the drum 50 extends from the frame 69.

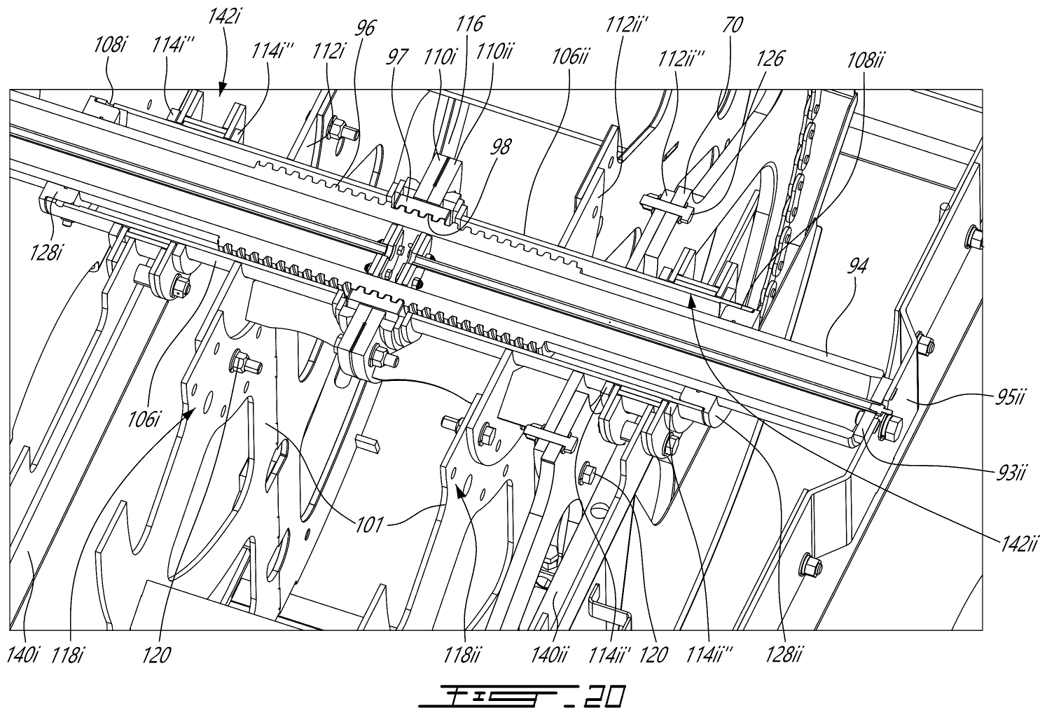

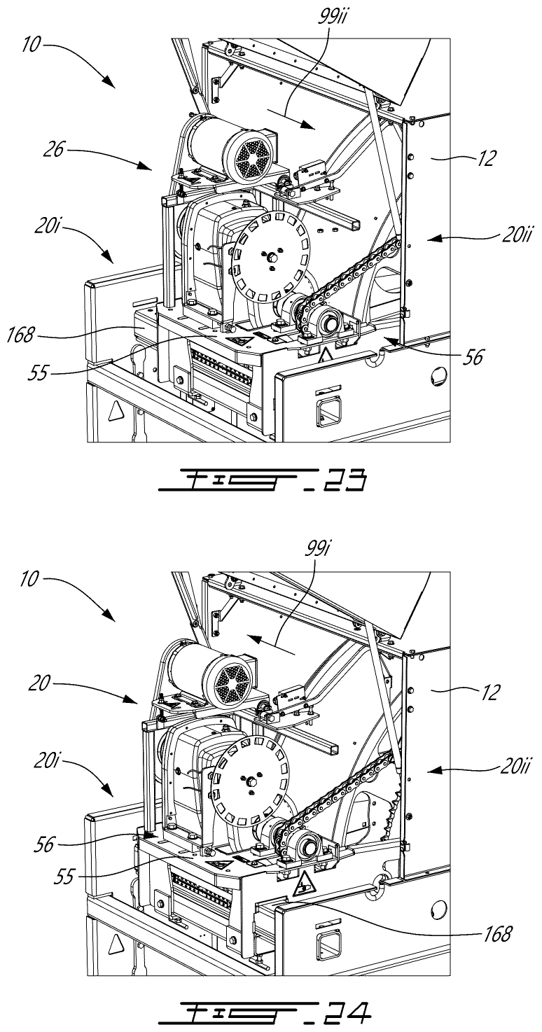

With reference to FIGS. 7, 21, 22 and 23, the front and underside part 156 of the table part 55 provides recess 158, a support 160 is secured thereto via brackets 162 mounted to the part 156 via fasteners 164 thereby forming a guide opening 166 (see FIG. 18) for receiving a guide 168 therein (see FIGS. 7, 19, 22, 23, and 24). As such, the table 55 slides along the guide 168 towards side 20ii (as shown in FIG. 23) when the sprocket 70, the hub and sleeve structure 104 and the drum 50 roll in the direction of arrow 58A causing the nut 97, the hub and sleeve structure 104 with the carriage 56 along with the drum 50 and the sprocket 70 to move in the direction of arrow 99ii. Likewise, the table 55 slides along the guide 168 towards side 20i (as shown in FIG. 24) when the sprocket 70, the hub and sleeve structure 104 and the drum 50 roll in the direction of arrow 58B causing the nut 97, the hub and sleeve structure 104 with the carriage 56 along with the drum 50 and the sprocket 70 to move in the direction of arrow 99ii.

With reference to FIG. 22, there is shown the bottom part 14 of the housing 12 which comprises the chassis 19 and includes front and rear panels 170A and 170B as well as side panels 172i and 172ii. The side panels 172i and 172ii have a respective cut-out section 174 providing a clearance space for the shaft 94 when mounted to the side plates 95i and 95ii, each side plate 95i, 95ii being secured to a respective panel 172i, 172ii. The bottom 176 of the chassis 19 is open. The front panel 170A is shown including the opening 28. A cable guide 178 provides for positioning the cable 30 therethrough during cable movement as provided herein. Reinforcement supports 180 are secured between the panels 172i and 172ii providing stability to the bottom part 14. The guide bar 168 is also secuted to panels 168.

Device 10 does not need pre-calibration, it can simply be set on the ground G and actuated to move the scrapers 46 along the pathway 40 as described herein.

Indeed, the example shown herein is an illustrative embodiment and the various components can be configured in other suitable ways.

The various features described herein can be combined in a variety of ways within the context of the present disclosure so as to provide still other embodiments. As such, the embodiments are not mutually exclusive. Elements of the embodiments and examples discussed can be combined within the context of the disclosure as those having skill in the art will readily appreciate. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

What is claimed is:

1. A cable drive unit for cleaning a free stall, the cable drive unit comprising:
a housing defining opposite lateral sides and opposite longitudinal ends defining respective cable openings;
a cable drive assembly mounted within the housing, the cable drive assembly comprising:
a shaft fixedly mounted to the lateral sides of the housing;
a drum being rotatably mounted to the shaft about a hub and sleeve structure thereof, the hub and sleeve structure mechanically interfacing with a length of the shaft for providing lateral displacement of the drum thereon between the lateral sides of the housing during rotation of the drum, the drum providing for receiving a wound cable thereon; and
an actuation assembly in operative communication with the drum for selectively imparting a rotational movement thereto,
wherein rotational movement of the drum provides for unwinding the cable therefrom to be moved outwardly of the opening of one of the longitudinal ends and simultaneously moving the cable inwardly at the other one of the longitudinal ends for being wound onto the drum thereby moving scrapers when mounted to the cable.

2. A cable drive unit according to claim 1, further comprising a support carriage positioned within the housing and movably mounted to the shaft and to the housing, the actuation assembly being mounted to the support carriage.

3. A cable drive unit according to claim 1, wherein the support carriage is mounted to the hub and sleeve structure via collar elements providing for the hub and sleeve structure to rotate therein.

4. A cable drive unit according to claim 2, wherein the carriage is slidably mounted to a guide at one of the one of the longitudinal ends of the housing.

5. A cable drive unit according to claim 3, wherein the carriage is slidably mounted to a guide at one of the one of the longitudinal ends of the housing.

6. A cable drive unit according to claim 1, wherein the hub and sleeve structure comprises an internal threaded surface and the shaft comprises a worm gear surface along the length for complementary engagement with internal threaded surface to provide the lateral displacement movement.

7. A cable drive unit according to claim 6, wherein the hub and sleeve structure encloses a nut therein, the nut comprising the internal threaded surface and being rotatable about the shaft in conjunction with the hub and sleeve structure and laterally displaceable along the length of the shaft during rotation thereof in conjunction with the hub and sleeve assembly.

8. A cable drive unit according to claim 7, wherein the hub and sleeve structure comprises a pair of hub and sleeve parts connected together about the nut for sealingly enclosing the nut therein.

9. A cable drive unit according to claim 1, wherein the hub and sleeve structure comprises disks radially extending therefrom connected to a frame of the drum.

10. A cable drive unit according to claim 1, wherein the actuation assembly is operatively connected to the hub and sleeve structure.

11. A cable drive unit according to claim 10, wherein the actuation assembly comprises a roller chain mounted to a sprocket and being connected to the hub and sleeve structure for imparting the rotational movement thereto.

12. A cable drive unit according to claim 11, wherein the hub and sleeve structure comprises a disk radially extending therefrom mounted a frame of the sprocket.

13. A cable drive unit according to claim 11, wherein the sprocket is positioned parallel to the drum.

14. A cable drive unit according to claim 11, wherein the sprocket has a small diameter than the drum and is positioned further away from a ground level than the drum.

15. A cable drive unit according to claim 11, wherein the sprocket is at least partially covered.
